(19) United States
(12) Patent Application Publication
(10) Pub. No.: US 2026/0209575 A1
(43) Pub. Date: Jul. 23, 2026

(54) EVA COMPOSITE HOT-MELT ADHESIVE FOR UV-PRINTED THREE-DIMENSIONAL PATTERNS, AND PREPARATION METHOD AND APPLICATION THEREOF

(71) Applicant: Hunan Shangxin New Materials Technology Co., Ltd., Hengyang (CN)

(72) Inventor: Min JIANG, Hengyang (CN)

(73) Assignee: Hunan Shangxin New Materials Technology Co., Ltd., Hengyang (CN)

(21) Appl. No.: 19/177,688

(22) Filed: Apr. 14, 2025

(30) Foreign Application Priority Data
Jan. 22, 2025 (CN) 202510097971.0

(51) Int. Cl. C09J 123/08; C09J 7/35

(52) U.S. Cl. CPC C09J 123/0853; C09J 7/35; C09J 2203/358; C09J 2301/304; C09J 2301/414; C09J 2423/04; C09J 2423/10; C09J 2431/00; C09J 2475/00

(57) ABSTRACT

An EVA composite hot-melt adhesive for UV-printed three-dimensional patterns, and a preparation method and an application thereof are provided. The EVA composite hot-melt adhesive includes thermoplastic polyurethane elastomer, ethylene-vinyl acetate copolymer, polyvinyl acetate, film-forming agent, viscosity modifier, and polypropylene; and a vinyl acetate content of the ethylene-vinyl acetate copolymer is ≥28 wt %. The EVA composite hot-melt adhesive uses an ethylene-vinyl acetate copolymer with a higher VA content as base resin, combined with thermoplastic polyurethane elastomer to improve properties of ductility and tensile of the material, and to enhance the hydrophilicity of EVA, thereby strengthening color fastness to washing after heat pressing and film formation. The addition of polyvinyl acetate improves the adhesion and color fastness to washing of the material. Through the synergistic action of all components, the material achieves excellent properties of tensile and color fastness to washing, enabling the formation of durable and wash-resistant three-dimensional pattern on fabric.

### CROSS REFERENCE TO THE RELATED APPLICATIONS

This application is based upon and claims priority to Chinese Patent Application No. 202510097971.0, filed on Jan. 22, 2025, the entire contents of which are incorporated herein by reference.

### TECHNICAL FIELD

The present invention relates to a field of printing materials technology, in particularly, it relates to an ethylene-vinyl acetate copolymer (EVA) composite hot-melt adhesive for Ultraviolet (UV)-printed three-dimensional patterns, as well as preparation method and application thereof.

### BACKGROUND

Printings on fabrics are mainly flat structures currently. However, a colored three-dimensional pattern not only creates diverse patterns but also enhances the tactile feel and visual depth of fabrics, favorited by consumers. Puff printing, for example, involves applying resin color pastes containing foaming agents onto fabrics, and after high-temperature steaming, the printed patterns expand to create a relief effect. However, the mechanical properties of this foaming material are poor, making it prone to deformation and lacking resistance in water washing.

Existing processes for printing three-dimensional color patterns on fabrics also include screen print, heat transfer vinyl (HTV) and silicone embossing. However, these printing processes are relatively complex and require significant investment in equipment. Screen printing, for instance, involves multiple steps such as plate making and color matching for producing three-dimensional color patterns. In the case of HTV or silicone embossing, it is necessary to apply colors, bake, cut out the desired shapes or patterns using laser, manually remove excess waste, and then apply heat pressing. These color pattern production processes are complex, high cost, and low in output, which is why they are rarely used on the printing of color three-dimensional pattern.

UV-print process mainly refers to the use of specialized UV inks to achieve localized or overall UV printing effects on UV printing machines. It is a plate-free full-color digital printing process and cannot be restricted by materials. UV-print process can be on the surface of T-shirts, glass, panels, plastics, stone, and leather, for color photo-level printing. UV-print process offers several advantages over traditional offset printing, such as vibrant colors, simple and rapid production processes, as well as plate-free, durability against wear, UV resistance, ease of operation, and fast printing speeds, and has a broad market prospect. However, the tensile strength of existing UV-printed products is relatively low, making them prone to tearing and deformation, which limits the application in printing color three-dimensional pattern on fabrics.

Patent CN108728017A proposes a hot-melt adhesive for fabrics and its preparation method. The adhesive includes EVA base resin, tackifier, viscosity modifier, filler, and crosslinking agent, and is prepared using a combination of melt blending and light irradiation. The resulting hot-melt adhesive exhibits good heat resistance and crack resistance. However, this adhesive fails to address the issue of poor color fastness to washing of EVA materials.

### SUMMARY

The objective of the present invention is to overcome the deficiencies and shortcomings of existing EVA hot-melt adhesives and to provide an EVA composite hot-melt adhesive with excellent tensile properties and adhesion, as well as high color fastness to washing.

Another objective of the present invention is to provide a method for preparing the EVA composite hot-melt adhesive.

A further objective of the present invention is to provide the use of the EVA composite hot-melt adhesive in the preparation of heat-transfer materials for three-dimensional patterns.

Yet another objective of the present invention is to provide a heat-transfer material for three-dimensional patterns.

The above objectives of the present invention are achieved through the following technical solutions:

The present invention protects an EVA composite hot-melt adhesive, including the following components in part by mass:

15-25 parts of thermoplastic polyurethane elastomer (TPU),
30-50 parts of ethylene-vinyl acetate copolymer (EVA),
8-16 parts of polyvinyl acetate (PVAc),
2-10 parts of film-forming agent,
1-5 parts of viscosity modifier, and
0.1-2 parts of polypropylene (PP);
wherein a vinyl acetate (VA) content of the ethylene-vinyl acetate copolymer (EVA) is ≥28 wt %.

The EVA composite hot-melt adhesive of the present invention uses an ethylene-vinyl acetate copolymer (EVA) with a high VA content as base resin, combined with thermoplastic polyurethane elastomer (TPU) to improve properties of ductility and tensile of the material, and to enhance the hydrophilicity of EVA, thereby strengthening color fastness to washing after heat pressing and film formation. The addition of polyvinyl acetate (PVAc) improves the adhesion and color fastness to washing of the material. Through the synergistic action of all components, the material achieves excellent properties of tensile and color fastness to washing.

Additionally, the EVA composite hot-melt adhesive of the present invention includes a specific amount of polypropylene (PP), which enhances the properties of hardness and film shear of the material. This is beneficial for waste removal after heat-transfer processing, preventing the adhesive film from stringing or residue.

It should be noted that controlling the VA content of the EVA is essential. This improves the compatibility between EVA and TPU, enhances the properties of ductility and tensile, and addresses the poor hydrophilicity of EVA, thereby improving color fastness to washing.

In some embodiments, the film-forming agent is a polyurethane resin and/or an acrylic resin, preferably polyurethane resin. Both polyurethane resin and acrylic resins offer good film-forming properties, with polyurethane resin having a more outstanding tensile strength, which is beneficial for improving the tensile properties of product.

Preferably, the polyurethane resin has a viscosity of 4000-6000 millipascal second (mPa·s) at 25° C.

In some embodiments, the PVAc has a viscosity of 1-4 mPa·s at 25° C., with a molecular weight of 25,000 to 35,000.

In some embodiments, the viscosity modifier is low-density polyethylene (LDPE). LDPE has good flowability, which addresses the fluidity of the liquid during coating and has excellent high-temperature resistance, preventing high-temperature exudation.

In some embodiments, the VA content of the ethylene-vinyl acetate copolymer is ≥ 30 wt %. Preferably, the VA content of the ethylene-vinyl acetate copolymer is 30-50 wt %.

In some embodiments, the ethylene-vinyl acetate copolymer has a melt flow rate of 1-40 g/10 min at 190° C. and 2.16 kg, preferably 5-35 g/10 min.

In some embodiments, the polypropylene can be selected from any one of homopolymer polypropylene (PP-H), polypropylene block copolymer (PP-B), and polypropylene random copolymer (PP-R), preferably polypropylene random copolymer, and more preferably metallocene polypropylene random copolymer.

In some embodiments, the components are present in the following components in part by mass:
18-22 parts of thermoplastic polyurethane elastomer (TPU),
35-45 parts of ethylene-vinyl acetate copolymer (EVA),
3-8 parts of polyvinyl acetate (PVAc),
10-14 parts of film-forming agent,
1-3 parts of viscosity modifier, and
0.5-1.5 parts of polypropylene (PP).

In some embodiments, in parts by mass, the composition also includes 1-3 parts of dispersant, 1-3 parts of humectant, 1-3 parts of curing agent, and 0.5-2 parts of leveling agent.

A method for preparing an EVA composite hot-melt adhesive, including the following steps: mixing the raw materials in the specified amounts with an organic solvent, stirring evenly at a temperature of 55-65° C., and casting to form the EVA composite hot-melt adhesive.

It should be noted that the preparation method of the present invention requires controlling the heating temperature within the specific range. If the temperature is too high, crystallization may occur, while if it is too low, agglomeration may happen.

An application of the EVA composite hot-melt adhesive in the preparation of UV-printed three-dimensional patterns.

A material for UV-printed three-dimensional pattern made from the EVA composite hot-melt adhesive through UV printing.

Compared with prior art, the beneficial effects of the present invention are as follows:

The present invention provides an EVA composite hot-melt adhesive that uses an EVA resin with a high VA content as base resin. An addition of TPU improves the properties of ductility and tensile of the material after film formation and enhances the hydrophilicity of EVA, thereby strengthening color fastness to washing after heat pressing and film formation. An inclusion of polyvinyl acetate (PVAc) improves the material's adhesion and color fastness to washing. Through the synergistic action of all components, the material achieves excellent properties of tensile and color fastness to washing.

### BRIEF DESCRIPTION OF THE DRAWINGS

FIG. 1 is a photograph of the three-dimensional pattern material on fabric after heat-transfer in Embodiment 4 of the present invention.

FIG. 2 is a photograph of the product shown in FIG. 1 in a stretched state after washing.

### DETAILED DESCRIPTION OF THE EMBODIMENTS

The present application is described in further detail below in conjunction with embodiments, the embodiments, however, do not limit the invention in any form. Unless otherwise stated, raw materials and reagents used in the following embodiments of the present invention are commercially available products.

Raw materials used in the following embodiments and comparative examples are as follows:

Ethylene-vinyl acetate copolymer (EVA):

EVA #1, with a VA content of 33 wt %; 150, Mitsui Chemicals, Japan.

EVA #2, with a VA content of 28 wt %; V6020M, JiangSu Sailbon Petrochemical Co., Ltd.

EVA #3, with a VA content of 18.5 wt %; V5110J, BASF-YPC Company Limited.

Thermoplastic polyurethane elastomer (TPU):

TPU #1: WHT-1150, Wanhua Chemical Group Co., Ltd.

TPU #2: 3190A, Zhejiang Huafon Chemical Co., Ltd.

Polyvinyl acetate: S0105, Wacker Chemie AG, Japan.

Polyurethane Resin: 627, Leader Formula Group, Taiwan.

LDPE: 1C7A, Sinopec Beijing Yanshan Company.

Polypropylene (PP): MU4016, Sinopec Beijing Yanshan Company.

Dispersant: Polyurethane-based; 330, Dongguan Risun New Material Company.

Humectant: TEGO 410, TEGO, Germany.

Curing agent: AE808, Guangzhou Yaxin New Material Company.

Leveling agent: BYK-420, BYK, Germany.

### Embodiments 1 to 3

These embodiments provide a series of EVA composite hot-melt adhesives, with a raw material components listed in Table 1 below.

TABLE 1
Raw Material Components for Embodiments 1 to 3 (Parts by Mass)

| | Embodiment # | | |
|---|---|---|---|
| Raw Material | 1 | 2 | 3 |
| EVA 1# | 40 | / | 40 |
| EVA 2# | / | 40 | / |
| TPU 1# | 20 | 20 | / |
| TPU 2# | / | / | 20 |
| Polyvinyl acetate | 12 | 12 | 12 |
| Polyurethane resin | 5 | 5 | 5 |
| LDPE | 2 | 2 | 2 |
| PP | 1 | 1 | 1 |
| Dispersant | 2 | 2 | 2 |
| Humectant | 2 | 2 | 2 |
| Curing agent | 2 | 2 | 2 |
| Leveling agent | 1 | 1 | 1 |

A preparation method of the EVA composite hot-melt adhesive includes the following steps:

Step 1, adding TPU particles to an appropriate amount of N,N-Dimethylformamide (DMF), stirring in a heating stirrer at 70° C. for 40 minutes at a speed of 200 revolutions per minute (rpm), allowing the TPU particles to dissolve in the DMF to form a liquid, and transferring the liquid to a constant-temperature container at 60° C. for temporary storage to maintain stable liquid flowability.

Step 2, adding EVA particles and PP particles to an appropriate amount of toluene and methyl ethyl ketone (MEK), stirring in a heating stirrer at 70° C. for 40 minutes at a speed of 230 rpm, allowing the EVA particles and PP particles to dissolve in the toluene and MEK to form a liquid, and transferring the liquid to a constant-temperature container at 60° C. for temporary storage to maintain stable liquid flowability.

Step 3, adjusting the temperature in a heating container to 170° C., mixing LDPE with water in a molten state to ensure uniform dispersion, then introducing the mixture into the TPU material from Step 1, stirring for 10 minutes to achieve phase integration, and obtaining a blended material.

Step 4, introducing the blended material obtained in Step 3 into the EVA/PP material from Step 2, stirring for 30 minutes at a low speed of 2500 rpm after adding a dispersant, then adding a polyvinyl acetate, a polyurethane resin, a humectant and a leveling agent, stirring for 60 minutes at a low speed, and maintaining the temperature at 60° C. throughout all stirring processes in Step 4, and then coating a resulting hot-melt adhesive slurry onto a release film, drying and obtaining a EVA composite hot-melt adhesive film.

### Embodiment 4

A three-dimensional pattern material for fabric heat transfer, made using a film of the EVA composite hot-melt adhesive from Embodiment 1, is prepared through the following steps:

(1) printing a three-dimensional pattern on the film of the EVA composite hot-melt adhesive using a UV printer with flexible UV-curable ink from Zhuhai Print-Rite New Materials Corporation Limited; and after printing, applying a PE protective film to the surface to obtain a patterned adhesive film; wherein the irradiation parameters are as follows: wavelength of 365 nm and single-lamp power of 25 W.

(2) removing a release film on the underside of the patterned adhesive film, and then applying the patterned adhesive film to a textile fabric, which is made of 100% cotton, heat-pressing the patterned adhesive film at 150° C. for 2 seconds using a heat press machine, and peeling off the PE protective film on the upper surface. At this point, the excess adhesive film around the pattern is transferred to the PE protective film, while the pattern is completely bonded to the fabric, resulting in a three-dimensional pattern material heat-transferred onto the fabric.

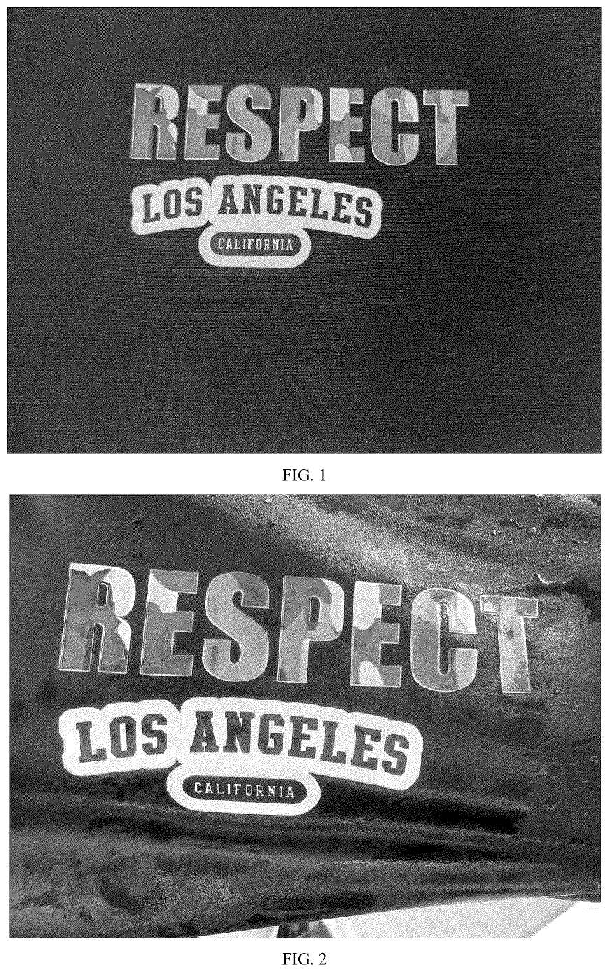

As shown in FIGS. 1-2, after being subjected to a soap washing test at 40° C. according to Method A (1) of Chinese Standard GB/T 3921-2008, the product does not easily stretch or break and shows no signs of color fading.

Additionally, samples were tested for color fastness to rubbing according to Chinese Standard GB/T 3920-2008. The results indicate that the samples have a dry rubbing color fastness rating of 3-4 and a wet rubbing color fastness rating of 2-3.

### Comparative Examples 1 to 3

These examples provide a series of EVA composite hot-melt adhesives, with a raw material components listed in Table 2 below.

TABLE 2
Raw Material Components for Comparative
Examples 1 to 3 (Parts by Mass)

| | Comparative Example # | | |
|---|---|---|---|
| Raw Material | 1 | 2 | 3 |
| EVA 1# | / | 60 | 40 |
| EVA 2# | 40 | / | / |
| TPU 1# | 20 | / | 20 |
| Polyvinyl acetate | 12 | 12 | / |
| Polyurethane resin | 5 | 5 | 5 |
| LDPE | 2 | 2 | 2 |
| PP | 1 | 1 | 1 |
| Dispersant | 2 | 2 | 2 |
| Humectant | 2 | 2 | 2 |
| Curing agent | 2 | 2 | 2 |
| Leveling agent | 1 | 1 | 1 |

A preparation method of the EVA composite hot-melt adhesive described in these comparative examples is the same as that in the above embodiments.

### Performance Testing

### Mechanical Property Testing:

Mechanical property tests were conducted on the EVA composite hot-melt adhesive materials from each embodiment and comparative example, with the results shown in Table 3.

Tensile strength: Tested according to the method of Chinese Standard GB/T 30776-2014.

Peel strength: Tested according to the method of Chinese Standard GB/T 2792-2014, with a sample width of 2.54 cm.

TABLE 3

| | Tensile | |
|---|---|---|
| | Strength (MPa) | Peel Strength |
| Embodiment 1 | 190 | Greater than 50 N |
| | | (Newton) |
| Embodiment 2 | 170 | Greater than 40 N |
| Embodiment 3 | 120 | Greater than 40 N |
| Comparative | 160 | Less than 20 N |
| Example 1 | | |
| Comparative | 40 | Greater than 50 N |
| Example 2 | | |
| Comparative | 175 | Less than 20 N |
| Example 3 | | |

The results indicate that the tensile strength of the EVA composite hot-melt adhesive of the present invention is above 120 MPa (Megapascal), and the peel strength is greater than 40 N.

Compared with Embodiment 1, the EVA composite hot-melt adhesive in Comparative Example 1, which uses an EVA resin with a lower VA content, shows a decrease in both peel strength and tensile strength.

The hot-melt adhesive in Comparative Example 2, which does not contain TPU, exhibits a significant reduction in tensile strength.

The hot-melt adhesive in Comparative Example 3, which does not contain polyvinyl acetate, has a decreased peel strength and poorer color fastness to washing for prepared patterns.

The above embodiments of the present invention are merely examples provided to clearly illustrate the invention and do not limit the implementation methods of the invention. Ordinary technicians in the field can make other changes or modifications based on the above description. It is neither necessary nor possible to exhaustively list all the implementation methods here. Any modifications, equivalent substitutions, and improvements made within the spirit and principles of the present invention should be included within the scope of protection of the claims of the present invention.

What is claimed is:

1. An ethylene-vinyl acetate copolymer (EVA) composite hot-melt adhesive, comprising, in part by mass, a raw material of:
15-25 parts of a thermoplastic polyurethane elastomer (TPU),
30-50 parts of an EVA,
8-16 parts of polyvinyl acetate (PVAc),
2-10 parts of a film-forming agent,
1-5 parts of a viscosity modifier, and
0.1-2 parts of polypropylene (PP);
wherein a vinyl acetate (VA) content of the EVA is ≥28 wt %.

2. The EVA composite hot-melt adhesive according to claim 1, wherein the film-forming agent is a polyurethane resin and/or an acrylic resin.

3. The EVA composite hot-melt adhesive according to claim 1, wherein the viscosity modifier is low-density polyethylene (LDPE).

4. The EVA composite hot-melt adhesive according to claim 1, wherein the EVA has a melt flow rate of 1-40 g/10 min at 190° C. and 2.16 kg.

5. The EVA composite hot-melt adhesive according to claim 1, wherein the PVAc has a viscosity of 1-4 mPa's at 25° C.

6. The EVA composite hot-melt adhesive according to claim 1, wherein the PP is a polypropylene random copolymer.

7. The EVA composite hot-melt adhesive according to claim 1, wherein the raw material further comprises, in part by mass: 1-3 parts of a dispersant, 1-3 parts of a humectant, 1-3 parts of a curing agent, and 0.5-2 parts of a leveling agent.

8. A method for preparing the EVA composite hot-melt adhesive according to claim 1, comprising the following steps: mixing the raw material in predetermined amounts with an organic solvent, stirring evenly at a temperature of 55-65° C., and casting to form the EVA composite hot-melt adhesive.

9. A method for preparing an ultraviolet (UV)-printed three-dimensional pattern, comprising using the EVA composite hot-melt adhesive according to claim 1.

10. A material for a UV-printed three-dimensional pattern, wherein the material is made from the EVA composite hot-melt adhesive according to claim 1 through a UV printing.

11. The method according to claim 8, wherein, in part by mass, the raw material further comprises: 1-3 parts of a dispersant, 1-3 parts of a humectant, 1-3 parts of a curing agent, and 0.5-2 parts of a leveling agent.

12. The method according to claim 9, wherein, in part by mass, the raw material further comprises: 1-3 parts of a dispersant, 1-3 parts of a humectant, 1-3 parts of a curing agent, and 0.5-2 parts of a leveling agent.

13. The material according to claim 10, wherein, in part by mass, the raw material further comprises: 1-3 parts of a dispersant, 1-3 parts of a humectant, 1-3 parts of a curing agent, and 0.5-2 parts of a leveling agent.
